(19) United States
(12) Patent Application Publication
(10) Pub. No.: US 2013/0297408 A1
(43) Pub. Date: Nov. 7, 2013

(54) DETERMINING ADVERTISEMENT PREFERENCES

(71) Applicant: LinkedIn Corporation, Mountain View, CA (US)

(72) Inventors: Anton P. Kast, San Francisco, CA (US); Robert D. Buch, Redwood City, CA (US)

(21) Appl. No.: 13/933,923

(22) Filed: Jul. 2, 2013

Related U.S. Application Data
(63) Continuation of application No. 12/790,880, filed on May 31, 2010.
(60) Provisional application No. 61/183,923, filed on Jun. 3, 2009.

(51) Int. Cl. G06Q 30/02

(52) U.S. Cl. CPC G06Q 30/0269
USPC 705/14.43; 705/14.66

(57) ABSTRACT

Selecting an advertisement is disclosed. A preference event associated with a first advertisement is received from a first user. A quality score for the first advertisement is determined based at least in part on the received preference event. An advertisement fulfillment request is received. The request is responded to by selecting an advertisement based at least in part on the quality score of the first advertisement.

### CROSS REFERENCE TO OTHER APPLICATIONS

This application is a continuation of co-pending U.S. patent application Ser. No. 12/790,880, filed May 31, 2010 and entitled DETERMINING ADVERTISEMENT PREFERENCES, which claims priority to U.S. Provisional Patent Application No. 61/183,923, entitled DETERMINING ADVERTISEMENT PREFERENCES and filed Jun. 3, 2009. The preceding patent applications are incorporated herein by reference for all purposes.

### BACKGROUND OF THE INVENTION

Advertisements are commonly placed alongside non-advertisement information (such as news articles and images) such that a viewer of the non-advertisement information will also be exposed to the advertisement. Unfortunately, viewers may ignore or not otherwise notice those advertisements. In the context of web pages, one reason that viewers ignore (whether consciously or subconsciously) advertisements is that publishers routinely locate the advertisements in standard locations such as to the right of the information, or in a header or footer, and over time viewers condition themselves to pay less attention to anything appearing in those locations. Viewers may be further prone to ignoring advertisements that comprise subject matter that is of little or no interest of them. Therefore there exists an ongoing need to improve advertisements.

### BRIEF DESCRIPTION OF THE DRAWINGS

Various embodiments of the invention are disclosed in the following detailed description and the accompanying drawings.

FIG. 1 illustrates an embodiment of an environment in which advertisements are displayed.

FIG. 2 illustrates an embodiment of an interface to a preference system.

FIG. 3 illustrates an embodiment of a content permalink.

FIG. 4 illustrates an embodiment of an interface to a preference system.

FIG. 5 illustrates an embodiment of an interface to a preference system.

FIG. 6 illustrates an embodiment of an interface to a preference system.

FIG. 7 is a flow chart illustrating an embodiment of a process for recording a preference for a content item.

FIG. 8A is an example of a content item.

FIG. 8B illustrates an embodiment of an interface to a preference system.

FIG. 9 illustrates an embodiment of an interface to a preference system.

FIG. 10 illustrates an embodiment of an interface to a preference system.

FIG. 11 illustrates an embodiment of an interface to a preference system.

FIG. 12 is a flow chart illustrating an embodiment of a process for receiving user preference information regarding an advertisement.

FIG. 13 is a flow chart illustrating an embodiment of a process for serving an advertisement.

FIG. 14 is a chart that illustrates an example of how advertising prices can change based on user preference events.

### DETAILED DESCRIPTION

The invention can be implemented in numerous ways, including as a process, an apparatus, a system, a composition of matter, a computer readable product embodied on a computer readable storage medium, and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘process’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

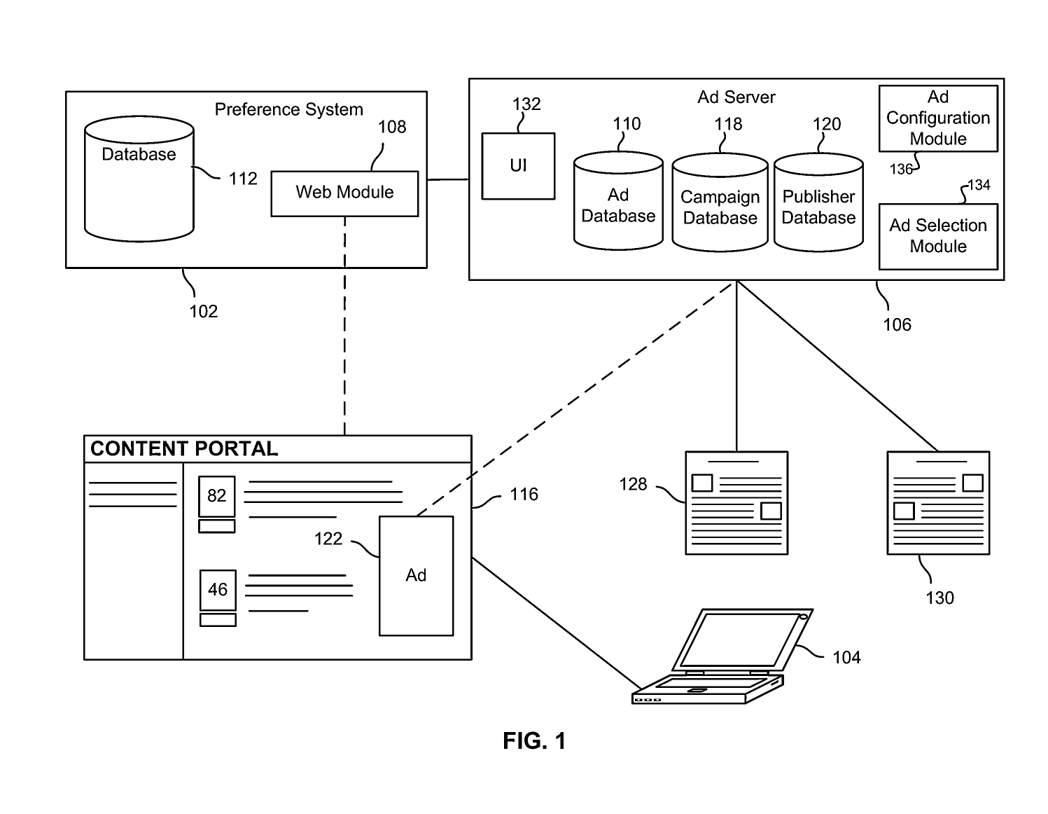

FIG. 1 illustrates an embodiment of an environment in which advertisements are displayed. In the example shown, users (e.g., a user of client 104) indicate preferences for items via preference system 102. Examples of items include news articles, blog posts, reviews, various other web pages, podcasts, photographs, and videos published by various publishers. Advertisements are another example of content for which users can indicate preferences. Examples of clients include personal computers, laptops, cellular phones/personal digital assistants, and other types of information appliances such as set-top boxes, game consoles, broadband routers, file servers, video servers, and digital video recorders, as applicable.

As will be described in more detail below, preference system 102 is configured to provide a link to content (e.g., a hyperlink to site 128) and summary information pertaining to that content, and also to allow users to indicate their preferences for the content by making a variety of interactions. For example, users can provide quantitative feedback such as a “thumbs up” (also referred to herein as a “digg”) to indicate their preference for content and can also “bury” content to indicate problems with the content. Users can also discuss the content with one another. These actions are referred to herein collectively as “preference events.” In various embodiments, publishers register their content with system 102. Users can also register content with system 102 by providing a uniform resource locator (URL) of the content. In such scenario, the user's registration (also referred to herein as a “submission”) of the content is another example of a preference event.

When content is submitted to system 102, an entry for the content is created in database 112. Information such as the submission time and the user who submitted the content are stored and counts associated with the content are initialized. Additionally, information associated with the submitting user is modified as appropriate. For example, a count of the number of content items submitted by the user is incremented and the content is made available in areas such as the user's profile and the profile areas of the user's friends (described in more detail below), if applicable.

Preference system 102 includes a web module 108 that provides typical web server functionality such as serving website 116 and capturing user input. In the example shown, web module 108 is an Apache HTTP server that supports running PHP scripts. In various embodiments, the functionality of website 116 is exposed to users via one or more APIs, as applicable. Web module 108 is interfaced with a database 112, such as through a MySQL database backend. Whenever a preference event occurs (e.g., whenever a user submits, diggs, buries, or comments on content), the event is recorded in database 112 along with associated information such as the identity of the user and a time/date stamp. In some embodiments, the infrastructure provided by portions of preference system 102 is located on and/or replicated across a plurality of servers rather than the entirety of preference system 102 being collocated on a single platform. Such may be the case, for example, if the contents of database 112 are vast and/or there are many simultaneous visitors to site 116.

Also shown in FIG. 1 is advertisement server 106, which is configured to provide advertisements (e.g., 122) for display on sites such as sites 116, 128, and 130. Ad server 106 can also provide advertisements to applications other than web browsers, such as via one or more APIs. Advertisers (or their representatives) provide ad configuration module 136 (via interface 132) with specifications for advertisements that are in turn stored in ad database 110. Advertisers can also create and maintain campaigns, which are stored in campaign database 118. Publishers registered with ad server 106 are able to specify various conditions under which syndicated advertisements should be shown on their sites. That information is stored in publisher database 120 and is also exposed via user interface 132. When requests for advertisements are received by ad server 106, ad selection module 134 selects an appropriate advertisement to be displayed. As will be described in more detail below, ad server 106 is configured to receive preference information from preference system 102, such as preference information associated with advertisements.

Whenever system 102 or server 106 performs a task, a single component, a subset of components, or all components of the respective system or server may cooperate to perform the task. Similarly, in some embodiments, portions of system 102 and/or server 106 are provided by one or more third parties.

In some embodiments, the functionality of ad server 106 is incorporated into system 102. Ad server 106 can also be physically separate from system 102, but operated by the operator of system 102. In various embodiments, ad server 106 is controlled by a party that is separate from the operator of preference system 102. In that scenario, ad server 106 is configured to obtain any necessary information from system 102 (e.g., pertaining to preference events) via an API or via scraping techniques, as applicable. Ad server 106 can also be configured to display advertisements using preference information from data sources other than system 102.

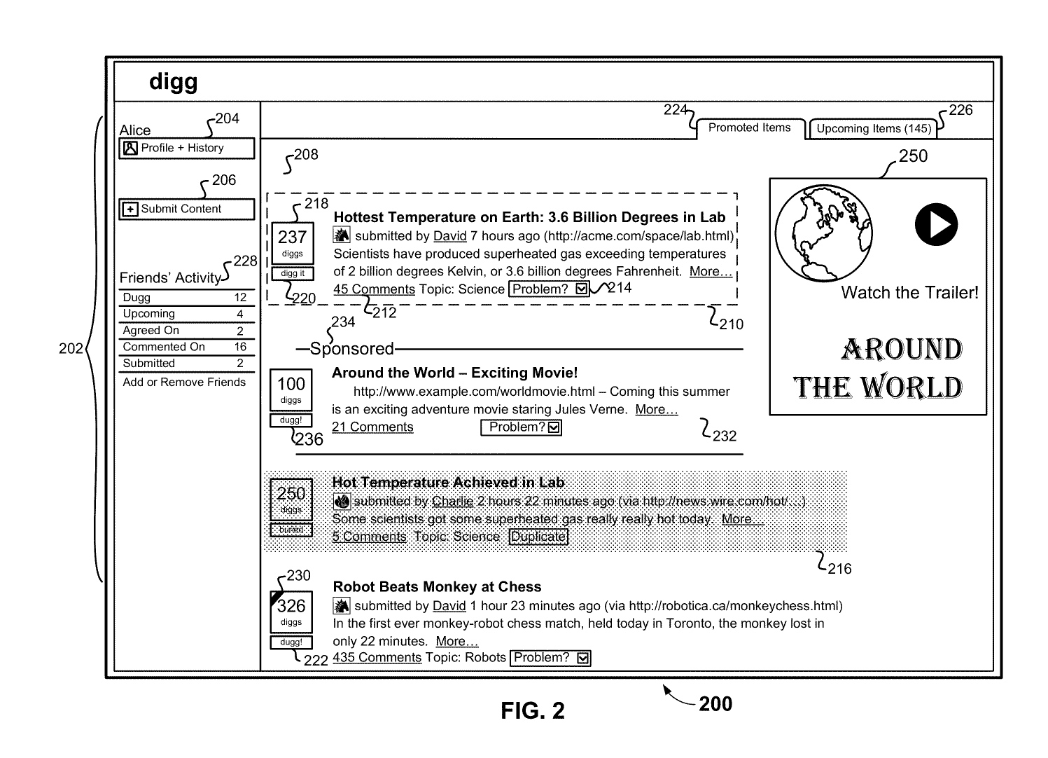

FIG. 2 illustrates an embodiment of an interface to a preference system. The example shown is an implementation of a portion of website 116, as rendered in a browser. A user, known as “Alice” is logged into site 116. Interface 200 includes a sidebar 202 that provides access to various system services. For example, by selecting region 204 of sidebar 202, Alice is presented with an interface that permits her to view her profile and manage account settings, such as her current email address and password; view previous preference events she's taken (her “history”); and access friend-related features described in more detail below. By selecting region 206, Alice will be presented with an interface through which she can submit content for inclusion on system 102.

Region 208 displays representations of multiple content entries such as entry 210. Entries include a title and other associated information, such as who submitted the content and when, the external URL of the content, the category to which the content belongs, and a summary of the content. Links are provided to the content directly (such as by clicking on the title), as well as to an area of site 116 associated with each specific content item, referred to herein as the content's “permalink.” For example, by clicking on the comments link (212) of the story, Alice will be presented with the comments portion of the permalink described in more detail below.

Content entry 210 also includes a problem reporting region 214. Users may report problems for a variety of reasons. For example, the first content entry and the third content entry are both news articles describing the same news—scientists superheating a gas. Accordingly, Alice selects the problem, “duplicate” content, which has the effect in this embodiment of graying out the content, represented here by stippling (216).

Each content entry has one or more scores associated with it. In the example shown, the “digg” score (218) for each item is displayed, as is an interactive region beneath the score (box 220) that allows a user to “digg” the item. The first item has been dugg 237 times, but has not been dugg by Alice. As described in more detail below, if Alice were to select region 218, a variety of actions would be immediately taken, including increasing the digg score of the story and updating the region's text from “digg it” to “dugg!” as shown in region 222.

Alice is currently viewing a “promoted items” (224) view of region 208. This means that content items presented to Alice on the current view of the interface have exceeded a promotion threshold. One example of a promotion threshold is the raw number of diggs. Other requirements/factors may be used for thresholding in addition to or instead of a digg score, such as requiring that a certain amount of time elapse between content submission and promotion, the speed with which content is being dugg by others, the identity of those digging the content, and other information associated with users that have dugg the content. Because some threshold of users must agree that a content item has merit before being promoted, content items shown in promoted view 224 are unlikely to contain spam or otherwise be inherently inappropriate for Alice's viewing. In some embodiments, different thresholds are used for different content. For example, the promotion of a math related news article may only require 100 diggs whereas an article about the president may require 500 diggs.

If Alice selects the upcoming content tab (226), only content which has not yet met the appropriate threshold will be displayed. For example, newly submitted content which has not yet been “dugg” by a sufficient number of people will be presented by selecting tab 226. In some embodiments, if content languishes in the upcoming pool for more than a certain period of time without receiving a sufficient digg score to be promoted (e.g., for a week), the content is removed from the pool and can only be found via its permalink or through a search. In some embodiments, such content is deleted from database 112 because it is indicative of problematic content such as spam, extremely biased or unfounded news articles, etc. Similarly, if enough users bury content, the content may be removed from the pool and/or database 112. In other embodiments, other views of content may be presented as applicable, such as a view that unifies both the promoted and the upcoming groups.

Portion 228 of interface 200 displays the recent activities (preference events) of Alice's friends. For example, in the last 48 hours, Alice's friends have submitted two content items, dugg twelve content items, and commented on sixteen content items, as reflected in dashboard 228. Of the twelve items her friends have dugg, four of the items have not yet been promoted. In some embodiments, assorted visual cues of her friends' activity are presented throughout website 116. In the example shown, items dugg by Alice's friends are notated by a banner (230) placed across the digg score. In other cases, other cues may be used.

Two advertisements are depicted in FIG. 2. The first, advertisement 250, is a typical display advertisement, selected for serving by ad server 106. The second advertisement (232) is included among user submitted content such as item 210. The advertisement is rendered in a manner similar to the other content items and includes a description, a digg button, a digg count, etc. The advertisement also includes a small indicator that it is “sponsored” material (234). The headline links to the campaign's landing page. As with the other content, the advertisement can be dugg, buried, and shared. In various embodiments, which actions users can take with respect to advertisements are configurable (such as by the advertiser). For example, when a user buries an advertisement, that action may impact the digg count of the advertisement, but may not actually remove the advertisement from being shown to the user (or greyed out). Optionally, the advertisement can have a permalink page (like any other content on the site) at which users can provide comments about the campaign, product, etc.

In various embodiments, the destination content is loaded in a frame. For example, advertisement 232 can be linked to a positive review of the movie being advertised on a third party site. The review page would load in a frame along with a link to a third party movie ticket vendor's page where users can buy movie tickets.

As users digg up (or bury down) particular advertisements, they indicate the advertisements that they consider to be relevant (and not-relevant) and provide real-time feedback to marketers (and any other interested parties) on the performance of their advertising messages. The resulting information can be used to ensure that advertisement campaigns (e.g., targeting digg users) resonate with the appropriate community, resulting in cost-efficient and effective campaigns. As will be described in more detail below, user preference information can also be used by ad server 106 in pricing the placement of advertisements.

The diggs of each user can also be used to target that particular user with future advertisements. For example, if a user diggs an ACME car advertisement, that user can be targeted in the future with other automobile ads. One way of accomplishing this is as follows. A user's digg of the ACME car advertisement is stored in database 112. The next time the user visits a site whose advertisements are served by ad server 106, ad server 106 queries database 112 to find out if that user has any relevant digging history to use to target with an advertisement. Ad server 106 would learn that the user has indicated interest in automobile advertisements and if any are available in ad server 106's inventory, an appropriate advertisement would be returned to the user.

In various embodiments, assumptions are made based on digging behavior. For example, if a user diggs story 534 (pertaining to movie box office business) and also diggs the ACME car advertisement, an assumption can be made that other users who digg article 534 will be interested in the ACME car advertisement. Furthermore, assumptions can be made that users who digg entertainment stories will be interested in the ACME car advertisement. Typically, these assumptions are based on the aggregation of multiple diggs of stories and advertisements before they are validated. One way of accomplishing this is as follows. Suppose that a user's entire digging history is stored in database 112. Each advertisement that the user diggs (or otherwise indicates a preference for or against) can also be associated in the database with all items that the user has previously dugg and any items that the user diggs in the future, thus storing associations of items and advertisements. As part of a periodic process, system 102 evaluates the associations and, if a correlation between certain stories and certain advertisements found, system 102 instructs ad server 106 to serve the advertisement to anyone with a similar digging history.

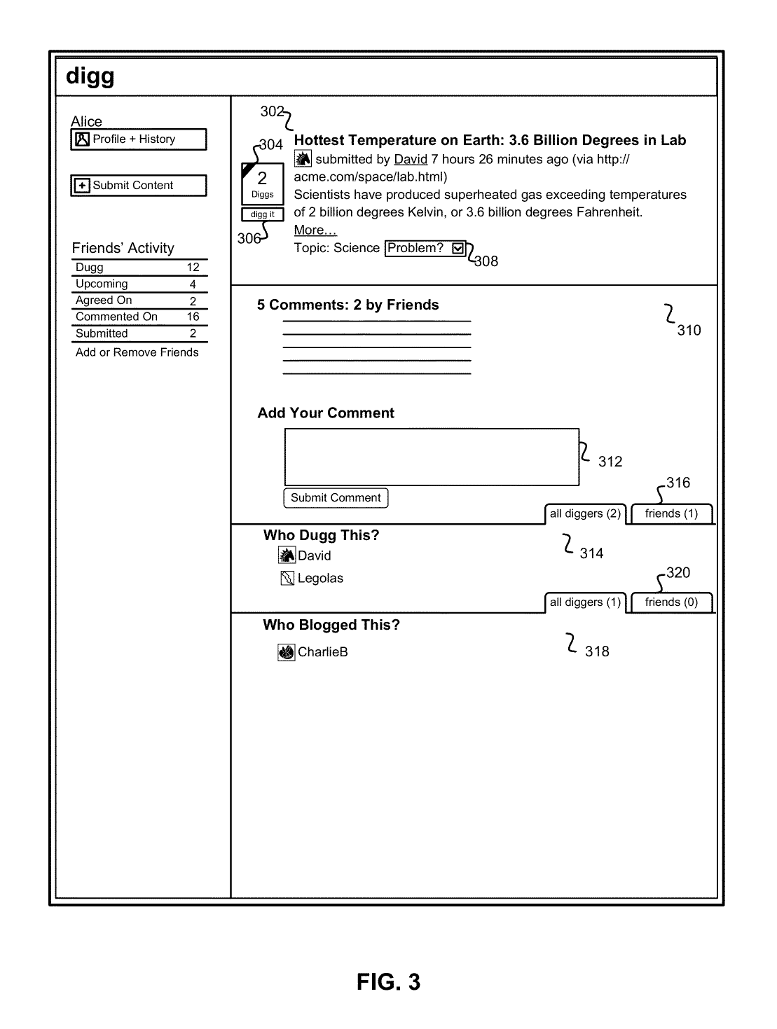

FIG. 3 illustrates an embodiment of a content permalink. The example shown is an implementation of a portion of website 116 as rendered in a browser. Each content item submitted to system 102 has a corresponding permalink page that includes content assembled dynamically from the information stored in database 112.

In the example shown, content 302 (a news article) was recently submitted to server 102 (26 minutes ago) by a user, David, who also dugg the story. Alice has David listed under her profile as her friend. As a result, the digg count includes a visual indication 304 that article 302 was dugg by a friend. In some cases, Alice and David know each other and have each other, mutually, on their list of friends. In other cases, the relation may be one sided. For example, David may be a columnist or famous personality whose opinion Alice values.

The digg score of article 302 is currently two (304) and the article has not met the threshold(s) required for the story to be promoted out of the “upcoming” area.

In the interface shown in FIG. 3, Alice can click digg box 306 to indicate her preference for the article. In some embodiments, additional actions are taken when Alice diggs a story. For example, if she has configured her blog settings, Alice can specify that stories that she diggs be posted to her blog as she diggs them. Similarly, Alice can configure her personal website (e.g., with a JavaScript) to automatically syndicate recent activities taken in response to stories.

She can report a problem with the article (bury it) by selecting an option from problem dropdown 308. Reporting options include “duplicate” article (to report that article 302 is a duplicate of another article), “bad link” (to report that the link to the full text of the article is defective), “spam” (to indicate that the article is fraudulent or spam), “inaccurate” (to indicate that there are factual problems with the article), and “old news” and “this is lame” to indicate that the article is not newsworthy. In some embodiments, bury events are anonymous site wide and are not replicated, for example, in a user's publicly accessibly digging history. One reason for this is to minimize the chances of a “flame war” occurring, for example, when a well-known user negatively rates content or a comment.

In various embodiments, different problem reporting options are made available based on the type of content. For example, for video content, a bury option of “poor quality” can be included to allow users to report blocky, choppy, or otherwise defective video. For products, a bury option of “mine broke” would allow a user to indicate that the product was flimsy.

Region 310 displays comments that users have made about article 302. Thus far, a total of five comments have been left about article 302, two of which were left by Alice's friends. Alice can submit comments by entering information into region 312 of FIG. 3.

In region 314, Alice is currently viewing a list of all the users who dugg article 302. Suppose David is Alice's friend, but Legolas is not. If Alice selects friends tab 316, the view in region 314 will change to show only David's name and avatar icon.

In region 318, Alice is currently viewing a list of the users who have blogged article 302. Charlie is the only person who has blogged the article so far and he is not Alice's friend. Therefore, if Alice were to select friends tab 320, no names would be shown.

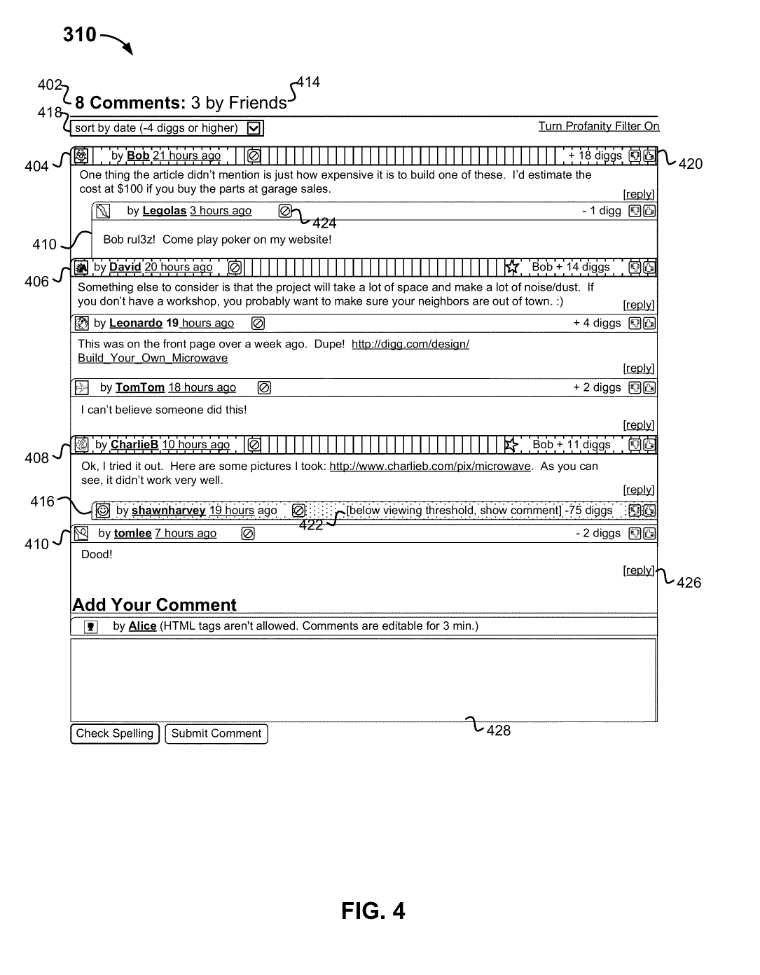

FIG. 4 illustrates an embodiment of an interface to a preference system. The example shown is an implementation of portion 310 of website 116, as rendered in a browser. In the example shown, Alice is viewing comments associated with an article. The article currently has eight comments (402), sorted by date. A threshold of −4 diggs or higher has also been applied (418). Thus, comment 416, which has been buried 75 times, is hidden. In the example shown, only the header of a buried comment is displayed, along with a link to reveal the hidden comment (422). Additionally, the header of comment 416 is greyed out to help a user visually distinguish between buried and non-buried comments.

Comment 404 was written by Bob, one of Alice's friends, as was comment 406 (written by David). In this example, comments written by friends are distinguished from other comments, such as through having a differently colored header. Comments dugg by friends are also distinguished. In the example shown, Bob has written an informative comment, which 18 people have dugg. If desired, Alice can digg or bury Bob's comment by selecting the appropriate icon at 420. In the example shown, the digg icon is a green thumb pointing up. The bury icon is a red thumb pointing down. If Alice selects one of the icons, Bob's comment score is immediately updated and the thumbs are greyed out to indicate to Alice that she's already registered her preference for Bob's comment.

Suppose Alice finds comment 410 to be off topic or otherwise unhelpful. If she chooses to bury the comment, in the example shown, the comment score for comment 410 will decrement by one point. In some embodiments, if enough people bury a comment, the comment is removed from the site and/or reported to an administrator. If desired, Alice can submit one or more comments of her own. For example, she may reply to an existing comment by selecting the reply button associated with the comment (426) or create a new comment by submitting text through region 428. When Alice submits or diggs a comment, that preference event is recorded in database 112 and her profile and the profiles of her friends are immediately updated.

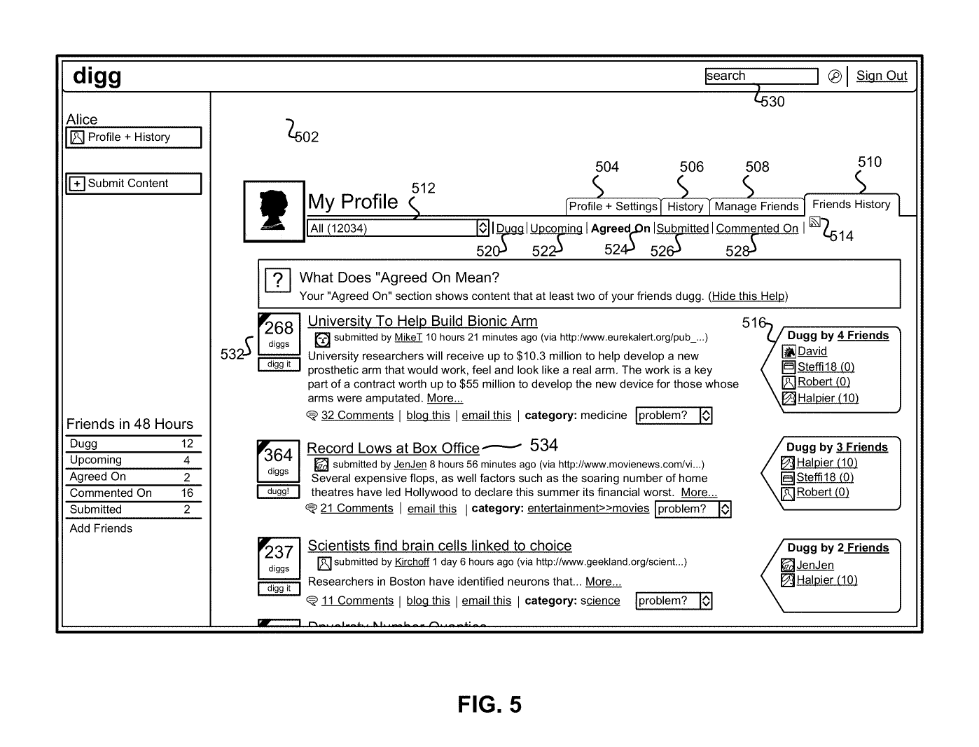

FIG. 5 illustrates an embodiment of an interface to a preference system. The example shown is an implementation of a portion of website 116 reached by selecting region 204, as rendered in a browser. In this example, Alice is viewing her profile (hereinafter “interface 502”), which has been subdivided into several tabbed views (504-510). A profile provides access to a variety of information, some of which may be publicly viewable and some of which may be kept private. Visitors to Alice's profile will be presented with a subset of the information available to Alice. For example, while Alice sees tab 504 being labeled “Profile+Settings,” a visitor to Alice's profile would see tab 504 as leading to Alice's “Profile” only. Similarly, tab 508, which by selecting allows Alice to add and remove friends, is only available to Alice and is hidden from visitors to her profile. Alice can also add friends by visiting other users' profiles and selecting an “add this user as my friend” option located in the profile.

Alice has currently elected to view her friends' history by selecting portion 510 of interface 502. The information presented can be further customized by selecting from subsets of information. For example, if Alice selects portion 520 of interface 502, she will be presented with a listing of all of the stories that have been dugg by at least one of her friends. If she selects portion 522, she will be presented with a list of stories that have been dugg by at least one of her friends but have not yet been promoted. If she selects portion 526, Alice will be presented with a list of stories submitted by her friends and by selecting portion 528, Alice will be presented with a list of stories that have been commented on by her friends. Other information (not shown) may also be presented in other embodiments, such as a list of comments that Alice and/or her friends have dugg.

In the example shown, Alice has elected to view stories “agreed on” by her friends (524). Each of the stories listed in this view have been dugg by at least three of Alice's friends. In various embodiments, Alice can configure the threshold and specify such information as the number of friends (or total number of diggs) required for a story to be agreed upon and/or define particular individuals whose digg is necessary for a story to be considered agreed upon, keywords that must be present in the story, etc. By making use of the “agreed on” view, Alice can readily discern the most important stories, even if she has thousands of friends. (I.e., if she sets the threshold to “agreed on by at least 10 friends” and has 1000 friends, the number of stories she is presented with is likely to be manageable and especially relevant or interesting.) Region 516 of interface 502 indicates that four of Alice's friends have dugg story 532. Alice can also see which of her friends have dugg story 532 by hovering her input device over the digg score box of story 532.

By selecting portion 506 of interface 502, both Alice and visitors to Alice's profile will be presented with Alice's history in a format similar to that currently shown, but limited to activities taken by Alice. Additionally, Alice may “undigg” stories and comments that she previously dugg by visiting her history.

Suppose Bob has listed Alice as his friend. Whenever Alice submits a new story, that new story immediately appears on Bob's “Friends—Submitted” list. Similarly, whenever David comments on an article, that fact is immediately reflected under Alice's tab 528 as shown in FIG. 5. As described herein, pages served by web module 108 include Asynchronous JavaScript and XML (Ajax) components. Other techniques may also be used to dynamically update site 116 as rendered in a browser (or other application) as appropriate.

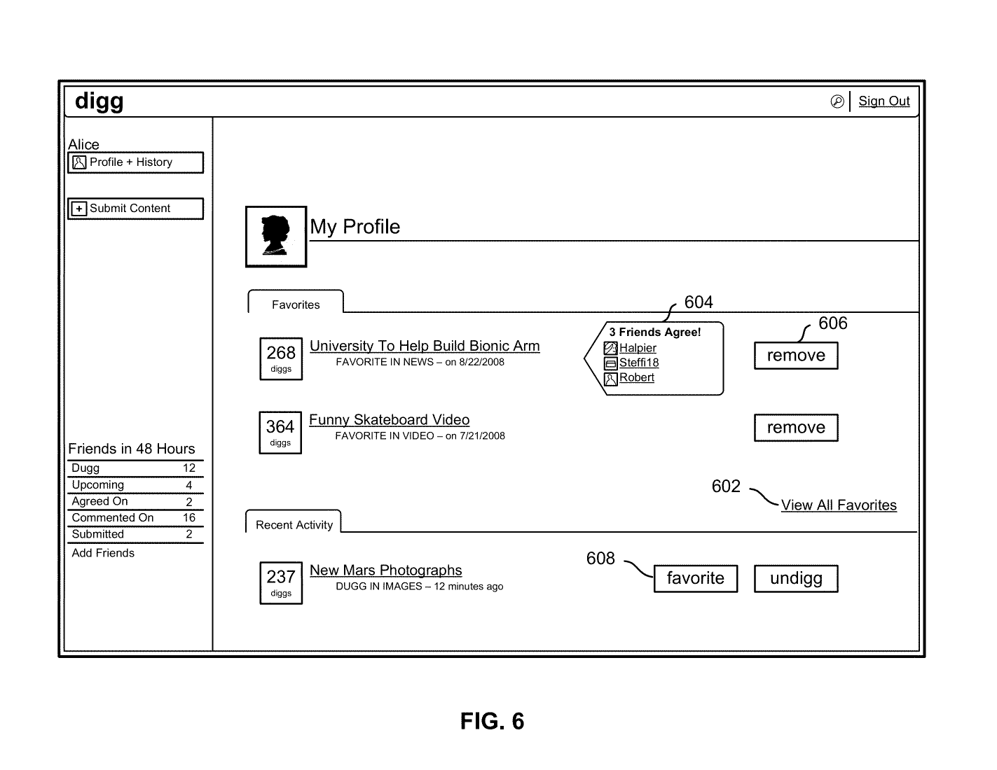

FIG. 6 illustrates an embodiment of an interface to a preference system. In the example shown, Alice is viewing a list of items that she has designated as being her favorite, e.g. by selecting region 608. In some embodiments, Alice can have a single favorite item at any given time listed in her profile, also referred to herein as “My #1,” indicating that the item is Alice's #1 favorite item. In other embodiments, Alice can have a single favorite item per category (e.g., favorite sports story, favorite politics story etc.) or per type of item (e.g., favorite restaurant, favorite video, favorite news item, favorite podcast, etc.). In any of the above cases, if she subsequently marks another item as “favorite” that newly selected item will replace the corresponding existing favorite item in Alice's profile. Items previously designated as “#1” are noted in an archive of “#1” items that can be accessed, e.g., by following a link 602.

In some embodiments, Alice can designate multiple favorites, in all categories/types of content, and a rolling list of the most recent designations is displayed in her profile, with older favorites accessible via link 602.

In various embodiments the history of Alice's favorites is color coded. For example, more recent favorites are green and older ones are red. Other visual indicators may also be used. For example, the more users that have the same content designated as favorite, the brighter the designation appears. If the same content is designated as favorite by many users right now, that content is “hot” and appears with flames around it in the “favorite” section of Alice's profile. If only a few people have that content marked as a favorite, the content may be “icy cold” as indicated by a blue color scheme.

Alice can remove her “favorite” designation of content by selecting region 606. For example, suppose Alice designated a particular MP3 player (one that she owns) as a favorite. The MP3 player was actually of poor quality and subsequently broke. Alice does not want other users to think that she still approves of it, so she removes the favorite designation. If instead of breaking, Alice merely received a newer, better player, she may wish to retain the favorite designation for the old player, and also mark her new player as favorite, so that other users know that she likes both players. In some embodiments, if Alice undiggs a particular content, any favorite designations that she may have made with respect to that content are automatically removed.

Alice can also view the favorite content of her friends (and other users) by visiting their respective profiles and selecting a “favorites” tab. Alice can also perform a user search to find other users with similar favorites to discover new friends and/or to discover new content. For example, Alice could designate a particular restaurant as her favorite and then perform a search to determine “where people who also like my #1 restaurant buy books?” Alice could designate a movie as being her favorite and then determine “what news stories are people who also share my favorite movie reading now?”

Alice can also see which content she and her friends have commonly designated as favorite, e.g. through information displayed in region 604. In some embodiments, Alice can also see the aggregate favorites of her friends by selecting a “see my Friends' #1s” link within her own profile, which in turn shows one favorite per friend, such as the item most recently designated as favorite by that friend. The aggregate view is customizable, and also allows, e.g., Alice to sort the favorites by the number of friends who at one point in time (or currently) also have designated the content as a favorite.

Statistics on the favorite content of users site-wide is tracked and can be displayed according to different periods of time, different groups of users, different categories/types of content, etc. For example, Alice can view “the content most often designated as favorite of all time,” search for “the most frequently #1 restaurant [bar, dry cleaner] in Chicago [or a zip code or an area code],” see “the product with the most favorite designations right now,” search for “the MP3 player with the most #1 designations between December 1 and January 31 of last year,” find “the #1 fiction book as designated on the lists of female users between the ages of 13 and 25,” and so on. A “top ten” list of favorite content can also be displayed, e.g. showing the relative positions of content based on the number of favorite designations, such as “this story is currently #3 in the ranking, up from #6 last week.”

Time-based information can also be used to indicate the “staying power” of the favorite designations for content. For example, if many people leave the same content at the top of their favorite list before replacing it with other content, this statistic can be measured, searched for, etc. Examples include a search for “the content with the longest average streak of being a user's favorite content,” “the content that, once designated as a favorite, remains a favorite the least amount of time,” and so on.

Favorite content can also be analyzed to determine particular topics or subjects of interest to a user which can subsequently be consumed by modules such as server 106. For example, suppose Alice designates as favorite a photograph of the fictional town of Springfield, a video clip of The Simpsons television show, and an article about a chain of convenience stores redecorating with a Simpsons theme. Collectively, the content marked as favorite indicates that “The Simpsons” is a concept in which Alice has a strong interest.

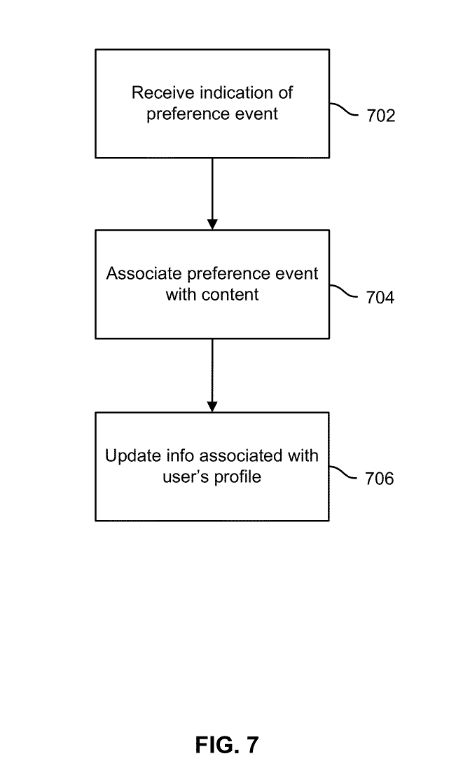

FIG. 7 is a flow chart illustrating an embodiment of a process for recording a preference for a content item. The process begins at 702 when an indication that a preference event has occurred is received. For example, when Alice selects digg box 306 shown in FIG. 3, her preference is received at 702. Other examples of preference events include submitting a content item, burying a content item, and commenting on an item. At 704, the preference event is associated with the content item and any associated scores are updated as applicable. For example, at 704, Alice and story 302 are linked in database 112 and the digg score of story 302 is increased in database 112 from two to three. At 706, information associated with the user's profile is updated. For example, views of Alice's digging history (including the friend views of users who have listed Alice as a friend) are updated to include the dugg story and an indication that Alice dugg it.

Additional Types of Content

As used herein, permalink pages for content items made available via system 102 include links or other pointers to the original form of the content (e.g., news articles and podcasts), such as may be hosted by a third party publishing site. In some embodiments, users submit the content itself (e.g. the full text of articles and the audio file) rather than or in addition to a link to the content and the techniques described herein are adapted accordingly.

As explained above, content contributions are not limited to news articles. Other content can also be submitted, dugg, buried, and/or commented on, and included in advertisements and the techniques described herein can be adapted as appropriate. For example, preference events taken on various types of content can be associated with a profile and shared with friends in a manner similar to that described in conjunction with FIG. 5.

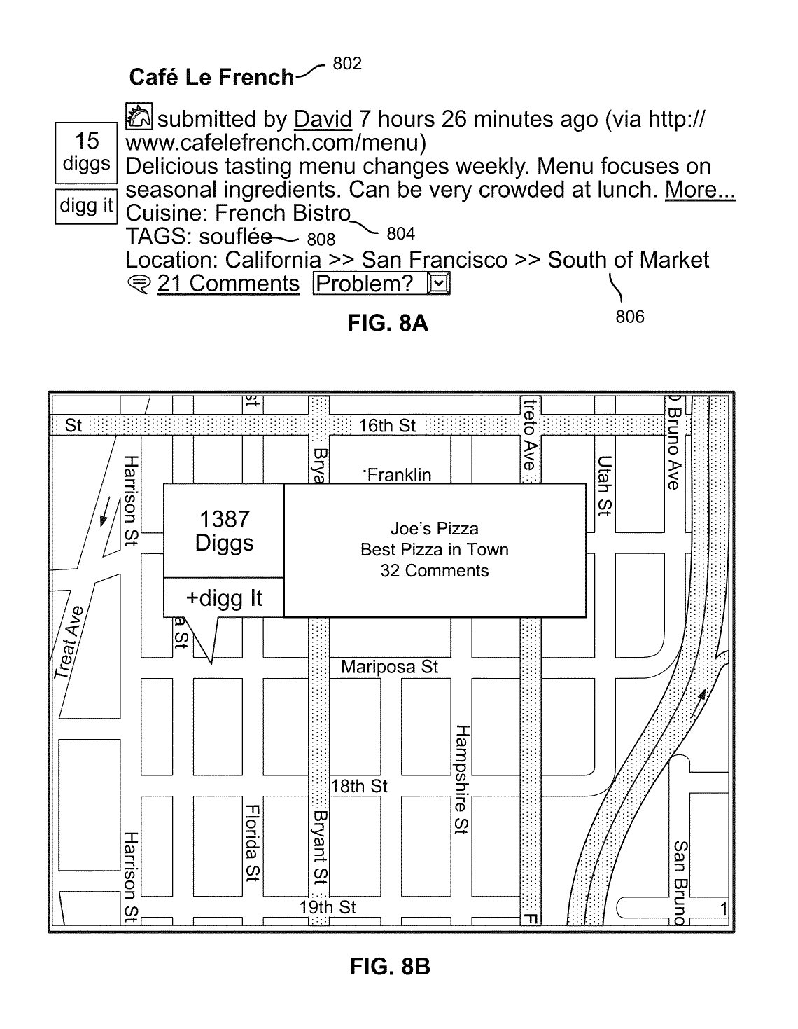

FIG. 8A is an example of a content item. The example shown represents a restaurant submission. The name of the restaurant (802) is included, as is information such as who submitted the restaurant, the URL of the restaurant, the type of cuisine it serves (804), and the general location of the restaurant (806). Users may perform such actions as searching for restaurants by cuisine type and/or location and limiting results to ones having a threshold number of diggs. Restaurants having no or few diggs can be displayed as “upcoming restaurants,” separated from “promoted restaurants” which have digg scores exceeding a threshold. Users can also supply additional information about their preferences for the restaurant, such as by supplying one or more tags (808) that indicate attributes such as “ambiance” or signature dishes. Which fields/tags are collected at submission time (and which, if any, can be added subsequently) and shown can be configured as appropriate depending on the type of content. For example, in the case of a product, a stock photo of the product may be included.

FIG. 8B illustrates an embodiment of an interface to a preference system. In the example shown, digging functionality has been combined with mapping functionality. When a user searches a map, such as a web-based map service, for nearby restaurants, entries on the map include an indication of the number of diggs a business has had and the ability to digg or comment on the business directly from the map interface.

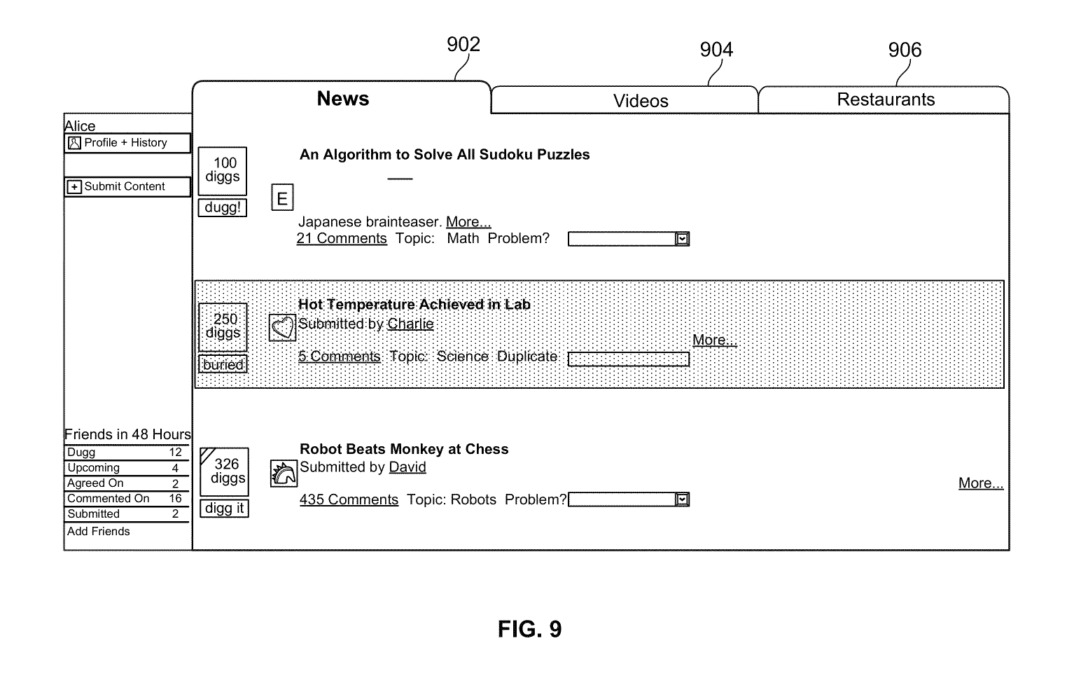

FIG. 9 illustrates an embodiment of an interface to a preference system. In the example shown, the interface unifies a user's preference for items across multiple genres of content. For example, the user can digg for news (902), videos (904), and restaurants (906) all through the same interface. Additionally, using the interface shown in FIG. 9, a visitor to Alice's profile can learn which news stories she's been digging as well as learn which restaurants she diggs or doesn't digg. Similarly, Alice can customize the views of each of the tabs (902, 904, 906) to display only restaurants her friends of agreed on, restaurants nearby (e.g., by selecting a region on a map or entering a ZIP code) that at least one friend has dugg, etc.

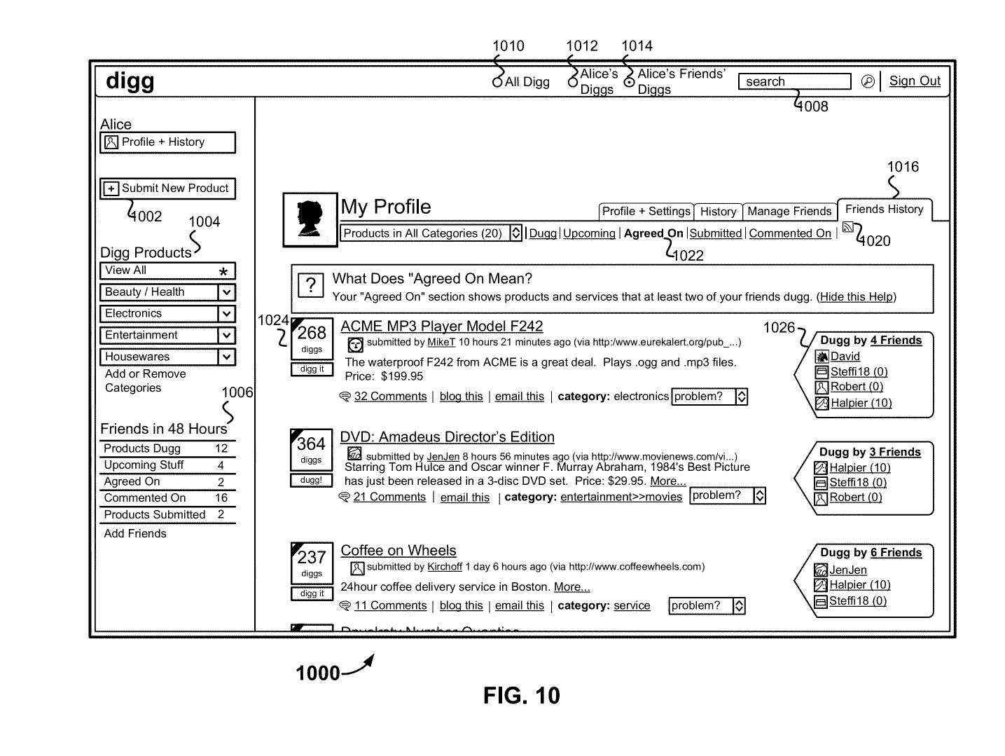

FIG. 10 illustrates an embodiment of an interface to a preference system. The example shown is an implementation of a portion of website 116 which includes the ability to submit, digg, and comment on products (including software), as rendered in a browser. In this example, Alice has selected to view products agreed on by her friends (1022).

Alice can submit a new product review by selecting portion 1002 of interface 1000. She can view products in one or more categories by selecting the appropriate portion of region 1004. Portion 1006 of interface 1000 displays the recent activities of Alice's friends in a dashboard format.

Region 1026 of interface 1000 indicates that four of Alice's friends have dugg product 1024, the ACME MP3 player. Alice can also see which of her friends have dugg product 1024 by hovering her input device over the digg score box of product 1024. In some embodiments, Alice can interact with region 1026, such as by being presented with a dialogue that offers to send an email to all of her friends listed in the region. In some embodiments, additional actions can be taken with product 1024. For example, Alice may be presented a “buy this product now” icon or link.

In some embodiments, profile visitors (including Alice) are presented with the option to search (1008) all of site 116 for product keywords (1010), search Alice's diggs for product keywords (1012), and/or search diggs made by Alice's friends for product keywords (1014). For example, a visitor to Alice's profile can search for MP3 players that she has dugg or commented on. In some embodiments, search interface 1008 includes the ability to filter results on meta information such as regions for DVDs, languages for books, etc. In some embodiments, views (and searches) can be limited by other factors, such as location (distance from Alice), availability (whether a product is in stock and how quickly it can arrive), etc.

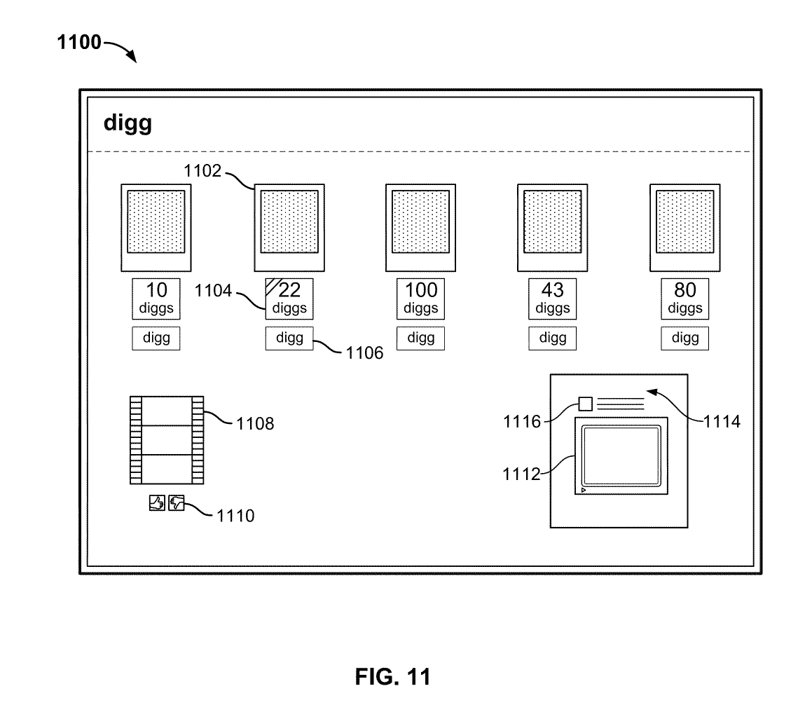

FIG. 11 illustrates an embodiment of an interface to a preference system. The example shown is an implementation of a portion of website 116 which includes the ability to submit, digg, and comment on photographs and video, as rendered in a browser. In the example shown, photograph 1102 was dugg by a friend, as indicated by banner 1104. By selecting digg box 1106, a visitor can indicate a preference for the photograph shown. In some embodiments, visitors indicate their preference for content such as video 1108 by selecting an icon such as icon 1110.

The content shown in interface 1100 can be presented in a variety of ways. For example, video content may be represented as an icon, such as the filmstrip icon shown at 1108. A screen shot of the first frame of the video may also be shown, and interactions, such as hovering a mouse over region 1108 could trigger actions such as causing the video to be played in the browser. In some cases, it may not be possible to embed the content directly into the interface shown in FIG. 11. In such a case, the video is shown in a format similar to content item 210 (1116) and a preview button 1114 is included. When preview button 1114 is selected, a video player 1112 automatically slides out in which the video can be displayed. Permalink pages, such as the one shown in FIG. 3, can be adapted for photograph and video content as appropriate, and users may comment, blog, and take other actions with respect to visual and other content (such as songs) as appropriate.

Advertisements

As explained above, preference system 102 can be configured to facilitate users indicating preferences for a variety of content (e.g., in addition to news stories), including advertisements.

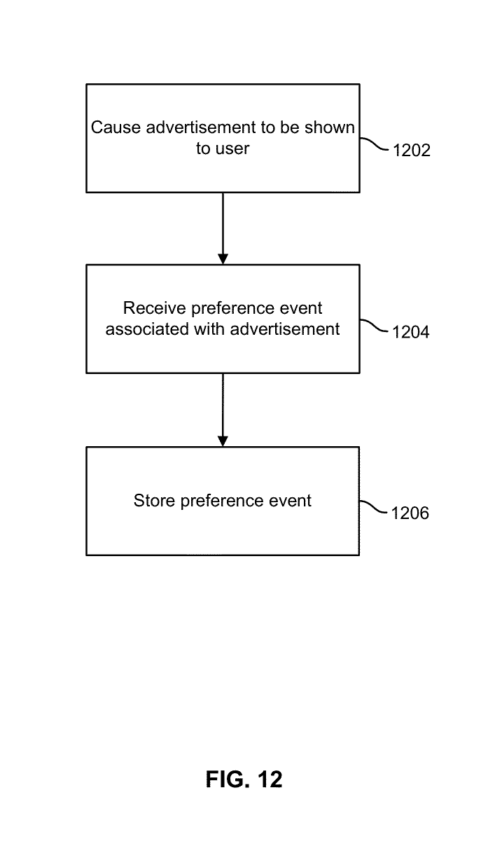

FIG. 12 is a flow chart illustrating an embodiment of a process for receiving user preference information regarding an advertisement. In some embodiments, the process shown in FIG. 12 is performed by system 102. The process shown in FIG. 12 can also be performed by ad server 106 and by system 102 working in conjunction.

The process begins at 1202 when an advertisement is caused to be shown to a user. As one example, when Alice visits site 116, advertisement 232 is presented to her at 1202. At 1204, a preference event associated with the advertisement is received. For example, if Alice were to click on digg box 236, a preference event would be received at 1204. At 1206, the preference event is stored. As one example, at 1206, the preference received at 1204 is stored in database 112. The received preference event can also be stored by ad server 106 instead of or in addition to being stored in database 112. For example, instead of being tracked in database 112 like other preference events, preference events associated with advertisements can be tracked exclusively by ad server 106 and may thus not be syndicated to friends or otherwise processed in the same manner as other preference events. Further, additional information can also be stored at 1206, such as the position of the advertisement as displayed, an identification of content items displayed above and below the advertisement, etc.

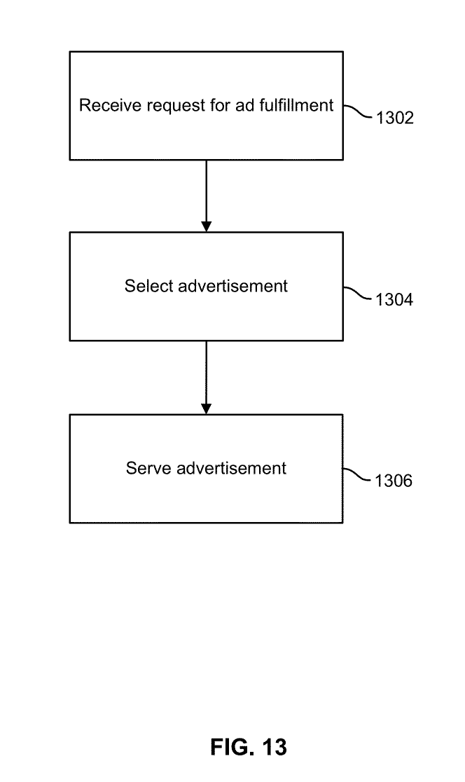

FIG. 13 is a flow chart illustrating an embodiment of a process for serving an advertisement. In some embodiments the process is performed by ad server 106. The process begins at 1302 when a request for an advertisement fulfillment is received. As one example, when Alice loads the web page shown in FIG. 2, ad server 106 receives a request for advertisement fulfillment at 1302.

At 1304, an advertisement is selected. As will be described in more detail below, users' preferences for advertisements (such as are received through the process shown in FIG. 12) can be used by ad server 106 as a factor to consider when selecting which advertisements to serve. Finally, at 1906, the advertisement is served, such as to client 104.

In various embodiments, ad server 106 employs a cost-per-click (CPC) performance-based pricing model. Advertisers set a budget and a max CPC bid and then the campaign will run until that budget is reached via ad configuration module 136, with the actual CPC fluctuating based on multiple factors, including bid density and an “quality score” of the advertisement. Bid density is the number of bids entered into the system competing for the same impressions, creating scarcity of supply, whether actual or artificial. The quality score can be based on a variety of factors (either individually or in combination), such as total number of diggs (and/or the reputation scores of the diggers, as described in more detail below), diggs relative to impressions (Digg Through Rate or DTR), DTR relative to other advertisements currently running on the site, clicks, Click Through Rate, and clicks and CTR relative to other advertisements currently running. The DTR means that if an ad has 1 Digg per 1 hundred impressions, the DTR would be 1%. Another ad that has 10 Diggs per 100 impressions would have a 10% DTR. The 10% DTR ad would have a higher quality score. Additional factors that can be considered include the velocity with which advertisements in a campaign (e.g., as a set of advertisements and/or individually) get diggs relative to time and impressions and the number of times a campaign gets shared.

Advertisers set a budget and a max CPC bid which are in turn stored in campaign database 118. Ad server 106 is configured to select advertisements with higher quality scores more often and will raise the CPC on ads with lower quality scores until those ads exceed their max-CPC bids, at which time they will stop being displayed. Accordingly, advertisements that are better received by users will receive better pricing (e.g., by being shown more often and with a lower average CPC) than those that are not. In some embodiments, advertisers with advertisements that have high quality scores are rewarded by ad server 106 with bonus budgets (e.g., 10% additional budget above what the advertiser has specified) instead of or in addition to the quality score factoring in at advertisement selection time.

Additional rules can also be considered when selecting advertisements for display. Consider advertisement 232, which appears in region 208 of FIG. 2. The other items included in region 208 are depicted because they were determined to have high quality scores as a result of the promotion process. Unlike the other items shown in region 208, advertisement 232 was not vetted through the promotion process. Instead, the operator of system 102 has specified that advertisements to be shown in region 208 must have previously received at least twenty diggs prior to being eligible for display in region 208. Until such time, the advertisements may be shown elsewhere on site 116, such as alongside items in the upcoming queue.

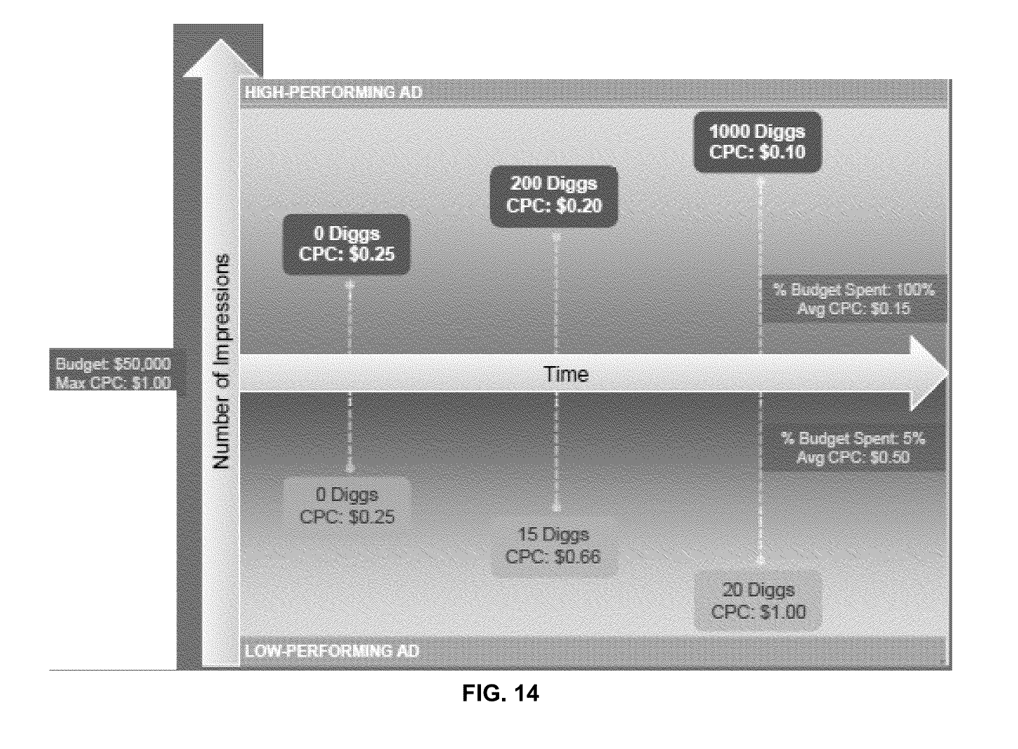

FIG. 14 is a chart that illustrates an example of how advertising pricing can change based on user preference events. Suppose a campaign from Advertiser A has an initially set maximum budget of $50,000 and a maximum CPC bid of $2. The initial CPC price can be set by system 102 (or publishers 128 and 130 as applicable) or by market forces (e.g. via an auction system where CPC price is set by advertisers bidding for placement where scarcity exists). Over time, as the ad quality score increases, the CPC required to maintain the same number of impressions decreases. Suppose Advertiser A wins an auction to have its advertisement placed at a $1.00 because the next highest bid was $0.95. If after 1 million impressions, the advertisement from Advertiser A has a high quality score, the CPC required for it to receive another 1 million impressions might be only $0.90, even though another advertiser (Advertiser B) is willing to pay $0.95. This could occur if Advertiser B's ad quality score is not yet established, or is lower than Advertiser A. Conversely, if Advertiser A's campaign performs poorly and the ad quality score is low, then ad server 106 could require Advertiser A to pay a CPC of $1.10 in order to beat out Advertiser B's bid of $0.95. If Advertiser A's ad quality score continues to decrease over time, the CPC required to beat out Advertiser B's bid of $0.95 would continue to increase until it reaches $2.00, at which point Advertiser A would no longer be permitted to run that campaign, unless it raises its max CPC bid above $2.00. In some cases, both advertisers' campaigns might both run simultaneously, but Advertiser A would be given more share of total impressions if its ad quality score, or its bid, is higher than Advertiser B.

In some embodiments, a portion of the advertisements displayed on site 116 are integrated with user preference feedback, while another portion of the advertisements are subject to traditional pricing. For example, in the interface shown in FIG. 2, advertisement 232 supports preference feedback (and is selected for display at least in part based on previous feedback), while advertisement 250 is subject to traditional pricing. In the example shown, both advertisement 232 and advertisement 250 belong to the campaigns of a single advertiser. The advertiser has specified, via ad configuration module 136, that if one of its ads is selected for display in region 208 (meaning that preference events may be received for it), then one of its traditional ads must be shown concurrently (e.g. advertisement 250).

Advertising content can be syndicated to or otherwise provided to third-party websites, such as websites owned by newspaper or television companies. For example, using the techniques described herein, a block of one or more advertisements (and corresponding digg/bury functionality) can be provided to the ACME Newspaper Company (e.g., as a 300×250 ad unit) which hosts its own news, or to a cable news network website. The audiences of those respective sites may likely have different preferences from those of website 116, and appropriate advertisements (and prices for those advertisements) can be selected for those sites independently of the advertisements that are made available on website 116.

By combining explicit user preference information (e.g., from diggs and buries) with other information, such as detailed user interest data from third-party web sites and frame interactions, advertising can be targeted and served in additional ways. For example, advertisements can be selected to appear on television, during movies in theatres, integrated with online video streaming services, embedded in web browsers, included inside instant messaging clients, in email messages and RSS feeds, on mobile phones, inside mobile device applications, as desktop software, in print media, during telephone hold, in web search results, and in any other context where user preference information can be collected and used.

User Reputation Information

A user reputation score approximates how good a particular user is at submitting and/or locating “good” content and in some embodiments how good a particular user is at identifying “bad” content. One way of determining a user reputation score for a particular user (e.g., Alice) is as follows. Each time Alice diggs a story in the upcoming story pool that is subsequently promoted, Alice's user reputation score is incremented by a fixed value. Each time Alice buries a story in the upcoming story pool that is subsequently removed from the pool, Alice's user reputation score is also incremented by a fixed value. In some embodiments multiple user reputation scores are maintained for Alice, e.g., with one relating to her success at digging stories and another relating to her success at burying stories. Alice may also have different user reputation scores for each category or type of content, for example, to reflect that she is astute at selecting sports related stories for promotion, but not very good at selecting photographs that are ultimately promoted.

As another example, whenever a story is promoted, each of the users that dugg that story (also referred to herein as having “voted” for the story) prior to the story being promoted receives a fractional share of the fixed value, added to their respective user reputation scores. The score of the original submitter is, in some embodiments increased by a higher fixed value than those that digg the story—in other embodiments the submitter is treated as being the first digger of the story. As another example, the first n users who digg a story, or any users who digg the story within n amount of time from when the story is submitted, have their user reputation scores incremented while later digging users do not, irrespective of whether the later digging users dugg the story prior to its promotion. The scores may be updated by an equal value, or may take into account the timing of the diggs. For example, the first person to digg a story that is ultimately promoted may receive a higher increase to his user reputation score than the fifth digger, who also receives an increase to his score. In various embodiments, only stories dugg in the last 30 days or some other time are considered when determining user reputation scores.

Yet another technique for calculating a user reputation score is as follows. Let u be a user, Iᵤ be the set of content dugg by the user in the last 28 days, Pᵤ be the subset of items in Iᵤ that were promoted and for which the user was an “early” digger, and Dᵢ be the current digg total of item i. The user reputation score (sᵤ for the user u can be expressed as:

$${s}_{u} = \frac{{Σ}_{i ∈ {S}_{u}} {D}_{i}}{\vert {I}_{u} \vert + 30} .$$

The number 30 in the denominator is a regulator that compensates for issues such as when a new or inactive user diggs an item which subsequently becomes very popular. It regulates exceptionally high user reputation scores that could otherwise result. In various embodiments, the total number of diggs made by a user is considered when determining a user reputation score so that an indiscriminate digger cannot achieve a high user reputation score by merely digging every single story in the upcoming pool.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A computer system-implemented method of displaying an advertisement, the method comprising:
presenting in an interface to the computer system a first plurality of content items having similar appearance;
receiving from multiple users, via the interface, preference events regarding the first plurality of content items;
operating the computer system to select an advertisement content item based at least in part on preference events received from a first user among the multiple users; and
presenting the selected advertisement content item to the first user, via the interface, with substantially the similar appearance.

2. The method of claim 1, wherein the similar appearance comprises:
an indicator of a number of positive preference events received from the multiple users for the corresponding content item; and
a first control actuable by a user to submit a positive preference event regarding the corresponding content item, if the user has not previously submitted a positive preference event for the content item.

3. The method of claim 2, wherein the similar appearance further comprises:
textual description of a subject of the content item.

4. The method of claim 3, wherein the similar appearance further comprises:
a link to further content associated with the content item.

5. The method of claim 2, wherein the similar appearance further comprises:
a second control actuable by a user to submit a comment regarding the content item.

6. The method of claim 2, wherein the similar appearance further comprises:
an indicator that a positive preference event for the content item has been received from at least one friend of the user, if a positive preference event for the content item has been received from at least one friend of the user.

7. The method of claim 2, wherein the similar appearance further comprises:
a second control actuable by the user to indicate a problem with the content item.

8. The method of claim 1, wherein the selected advertisement content item is presented with a notification that the selected advertisement is sponsored.

9. The method of claim 1, further comprising:
presenting to the first user, via the interface, a second advertisement related to a subject of the selected advertisement content item.

10. The method of claim 1, wherein presenting the selected advertisement content item to the first user, via the interface, with substantially the similar appearance, comprises:
presenting in the interface multiple selectable partitions of content items, including:
a first partition encompassing content items for which threshold numbers of positive preference events have been received from the multiple users; and
a second partition encompassing content items for which the threshold numbers of positive preference events have not been received.

11. The method of claim 10, wherein presenting the selected advertisement content item to the first user, via the interface, with substantially the similar appearance, further comprises:
presenting in the interface a summary of preference events submitted by friends of the first user.

12. A computer program product for displaying an advertisement, the computer program product being embodied in a non-transitory computer readable storage medium and comprising instructions for:
presenting in an interface to the computer system a first plurality of content items having similar appearance;
receiving from multiple users, via the interface, preference events regarding the first plurality of content items;
operating the computer system to select an advertisement content item based at least in part on preference events received from a first user among the multiple users; and
presenting the selected advertisement content item to the first user, via the interface, with substantially the similar appearance.

13. A system, comprising:
one or more processors; and
a memory coupled to the one or more processors, wherein the memory is configured to provide the one or more processors with instructions that, when executed, cause the one or more processors to:
present in an interface to the computer system a first plurality of content items having similar appearance;
receive from multiple users, via the interface, preference events regarding the first plurality of content items;
operate the computer system to select an advertisement content item based at least in part on preference events received from a first user among the multiple users; and
present the selected advertisement content item to the first user, via the interface, with substantially the similar appearance.

14. The system of claim 13, wherein the similar appearance comprises:
an indicator of a number of positive preference events received from the multiple users for the corresponding content item; and
a first control actuable by a user to submit a positive preference event regarding the corresponding content item, if the user has not previously submitted a positive preference event for the content item.

15. The system of claim 14, wherein the similar appearance further comprises:
textual description of a subject of the content item; and
a link to further content associated with the content item.

16. The system of claim 14, wherein the similar appearance further comprises:
an indicator that a positive preference event for the content item has been received from at least one friend of the user, if a positive preference event for the content item has been received from at least one friend of the user.

17. The system of claim 13, further comprising:
presenting to the first user, via the interface, a second advertisement related to a subject of the selected advertisement content item.

18. The system of claim 13, wherein presenting the selected advertisement content item to the first user, via the interface, with substantially the similar appearance, comprises:
presenting in the interface multiple selectable partitions of content items, including:
a first partition encompassing content items for which threshold numbers of positive preference events have been received from the multiple users; and
a second partition encompassing content items for which the threshold numbers of positive preference events have not been received.
